(19) United States
(12) Patent Application Publication
(10) Pub. No.: US 2003/0134542 A1
(43) Pub. Date: Jul. 17, 2003

(54) Connector package having mark for preventing misorientation of connectors in the package

(76) Inventor: Wen He, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/266,489

(22) Filed: Oct. 7, 2002

(30) Foreign Application Priority Data
Jan. 11, 2002 (TW) 912200171

(51) Int. Cl. H01R 13/64

(52) U.S. Cl. 439/677

(57) ABSTRACT

A package (1) for packing electrical connectors (4) includes an elongate base (2). The base comprises a top surface (27) from which the connectors (4) are correctly received in the package, and a bottom surface (28) opposite the top surface. The base includes a plurality of rectangular holes (21) and rectangular cavities (23) arranged in a matrix for receiving the electrical connectors therein. A triangular bottom wall (20) is provided in the hole (21) at an upper left corner of the package for functioning as an indicating device for facilitating an operator to easily distinguish the top surface from the bottom surface of the package. Accordingly, the operator can easily correctly put the connectors into the package from the top surface of the package.

### BACKGROUND OF THE INVENTION

1. Field of the Invention

The present invention relates to a package, and particularly to a package for receiving electrical connectors therein for easy transportation and handling of the connectors and achieving a protection to the connectors from dust and contaminant.

2. Description of Related Art

Referring to FIG. 3, a CPU socket connector package 9 comprises an elongate base 91, plural rectangular holes 910 defined in two end portions of the base 91, and plural rectangular cavities 911 formed between the rectangular holes 910. Each cavity 911 has a bottom wall 9111. The bottom walls 9111 are provided for increasing the strength and integrity of the package 9. The base 91 forms four ribs 912 respectively extending into four sides of each of the rectangular holes 910 and rectangular cavities 911. Central Processing Unit (CPU) Socket Connector 8 (only one being shown) normally are mounted from a top side of the package 9 into the holes 910 and cavities 911, respectively, in which the connectors 8 rest on the ribs 912. Since the package 9 is made of transparent material, and it has a similar appearance viewed from its top side (FIG. 3) and bottom side (FIG. 4), an operator can be easily confused to wrongly mount the connectors 8 into the package 9 from the bottom side thereof. When doing so, about one third of a height of the connectors 8 is exposed to air, whereby contaminant and dust can easily enter the connectors to adversely affect their quality.

Thus, an electrical connector package having a means which can enable an operator to easily distinguish top and bottom sides of the package so that the operator can mount connectors into the package from a correct side is needed to overcome the disadvantages of the related art package.

### SUMMARY OF THE INVENTION

Accordingly, an objective of the present invention is to provide an electrical connector package having a means for facilitating a user to tell top side from bottom side of the package so that the user can easily mount connectors from a correct side, i.e., the top side of the package into the package.

In order to achieve the objective set forth, a package for electrical connectors includes an elongate base. The base includes plural holes and cavities arranged in a matrix having three rows and six columns. Each cavity is provided with a rectangular bottom wall for enhancing the integrity and strength of the package. A triangular bottom wall is provided in the hole at an upper left corner of the package. The triangular bottom wall is used as an indicating device for facilitating an operator to distinguish top and bottom sides of the package, whereby the operator can easily correctly mount socket connectors into the cavities and holes of the package from the correct top side of the package.

Other objects, advantages and novel features of the invention will become more apparent from the following detailed description of the preferred embodiment when taken in conjunction with the accompanying drawings.

### BRIEF DESCRIPTION OF THE DRAWINGS

FIG. 1 is a top perspective view of a connector package in accordance with the present invention and a socket connector;

FIG. 2 is a bottom perspective view of the package of FIG. 1;

FIG. 3 is a top perspective view of a related art connector package and a socket connector; and

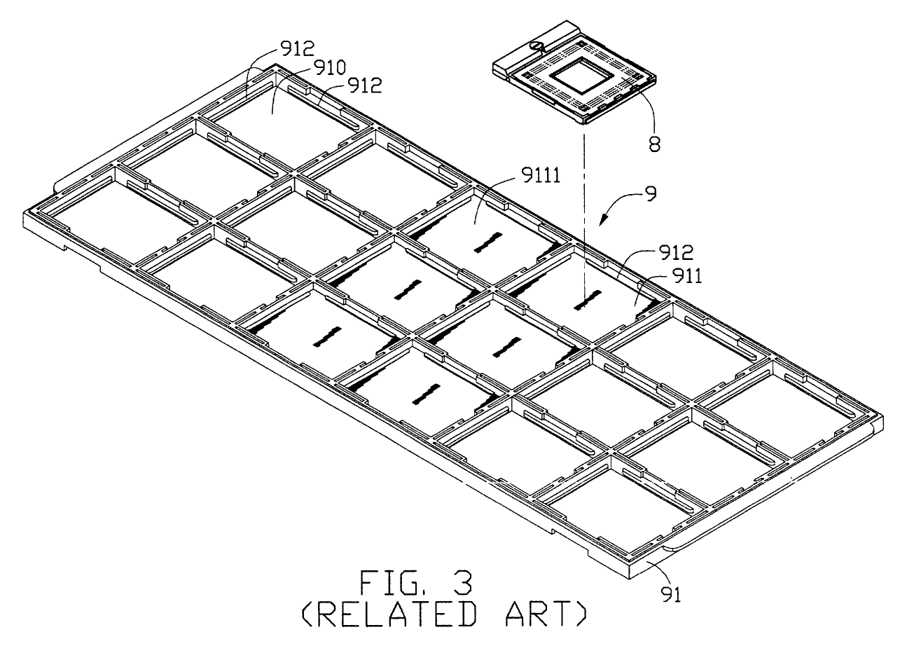

FIG. 4 is a bottom perspective view of the connector package of FIG. 3.

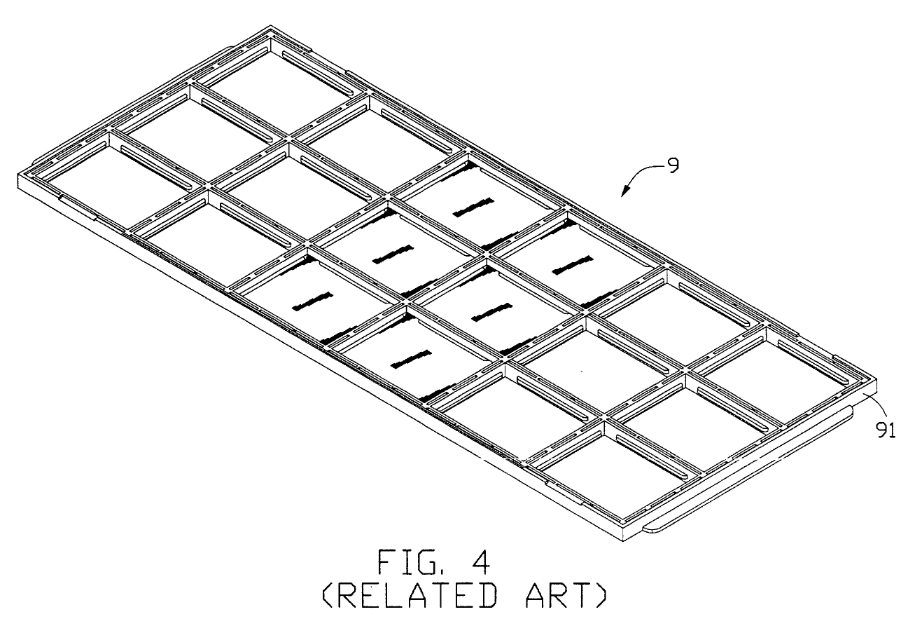

### DETAILED DESCRIPTION OF THE INVENTION

Reference will now be made to the drawing figures to describe the present invention in detail.

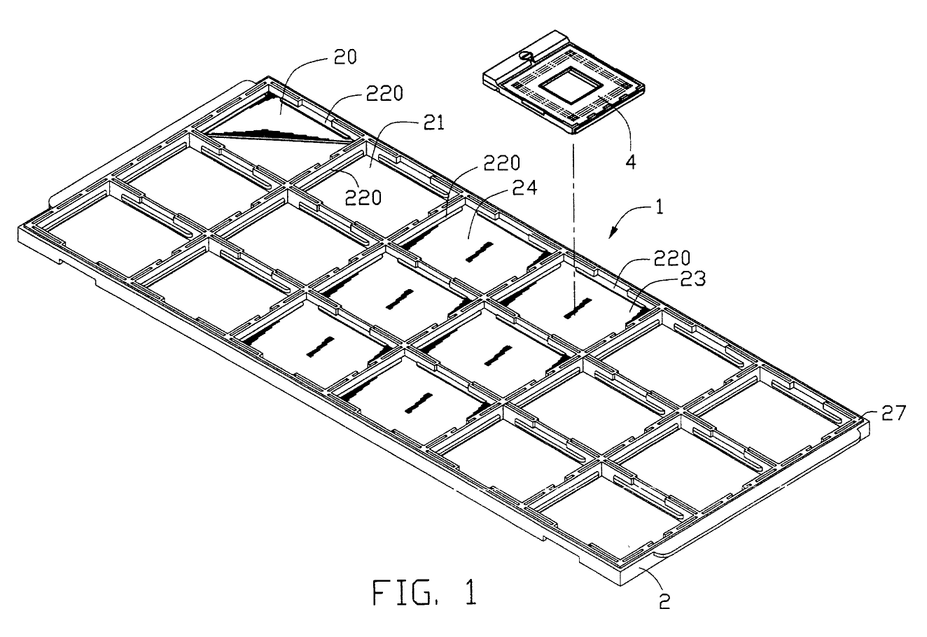

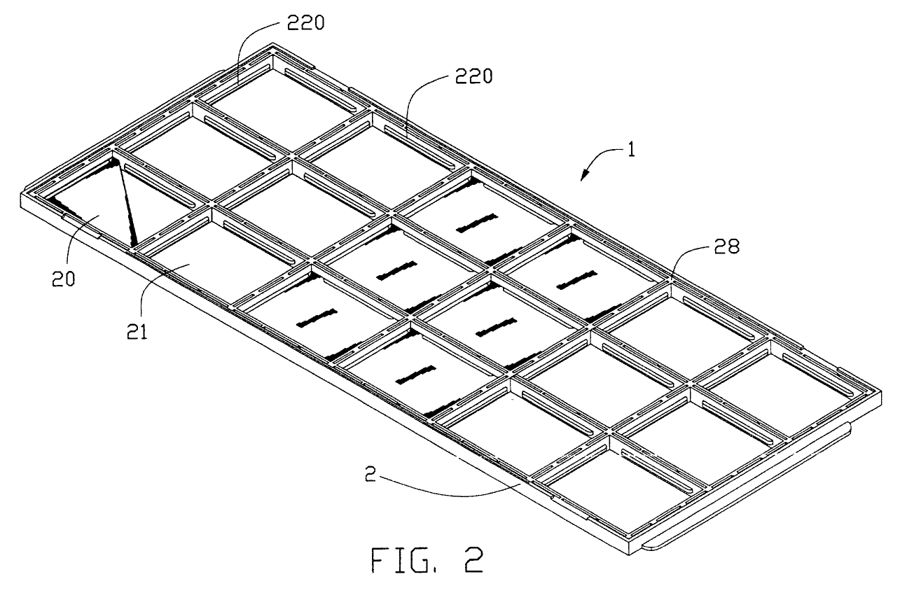

Referring to FIGS. 1 and 2, a package 1 in accordance with the present invention is used for packaging electrical socket connectors 4 (only one shown in the drawings) which are used for connecting CPUs to mother boards of computers.

The package 1 includes an elongate base 2. The base 2 has a top surface 27 via which the connectors 4 are normally mounted into the package 1, and a bottom surface 28 opposite to the top surface 27. The base 2 includes plural rectangular holes 21 in opposite ends thereof, and plural rectangular cavities 23 between the holes 21. The holes 21 in each end of the base 2 and the cavities 23 are arranged in a matrix having two columns and three rows. Thus, the package 1 can receive a total number of eighteen socket connectors 4. Each cavity 23 includes a rectangular bottom wall 24 for enhancing integrity and strength of the package 1. Four ribs 220 are extended respectively into four sides of each of the holes 21 and the cavities 23 for supporting the socket 4 mounted into a corresponding hole 21 or cavity 23. A distance between the ribs 220 and the top surface 27 of the base 2 of the package 1 is larger than a height of the socket connector 4 so that when the sockets 4 are mounted into the holes 21 and cavities 23 via the top surface 27, the sockets 4 are totally embedded into the package 1.

To guide an operator to easily correctly mount the connectors 4 into the package 1 via the top surface 27, rather than via the bottom surface 28, a triangular bottom wall 20 is provided in the hole 21 at an upper, left corner of the base 2 as shown in FIG. 1. The triangular bottom wall 20 is located below the ribs 220 in the hole 21, and has a right-angled configuration. The triangular bottom wall 20 functions as an indicating device for facilitating the operator to easily distinguish the top surface 27 from the bottom surface 28 of the base 2 since when the package 1 is horizontally oriented only when the triangular bottom wall 20 is shown at the upper left corner or a lower right corner of the base 2, the top surface 27 of the base 2 is located at a top side thereof. Thus, the operator can easily correctly mount the connectors 4 into the package 1 via the top surface 27.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A package for electrical connectors comprising:
a base having a top surface from which the electrical connectors can be correctly received in the package, a bottom surface opposite the top surface, and a plurality of rectangular spaces each for receiving a corresponding connector therein, said rectangular spaces being arranged in a matrix, means provided in one of the spaces for facilitating a user of the package to distinguish the top and bottom surfaces of the base whereby the user can put the connectors into the package from the correct top surface.

2. The package as claimed in claim 1, wherein the spaces include holes and cavities, the base has a bottom wall in each of the cavities.

3. The package as claimed in claim 2, wherein the holes and the cavities each have a rectangular shape, and the bottom wall has a rectangular shape.

4. The package as claimed in claim 3, wherein the base has four ribs extending respectively into four sides of each of the holes and cavities.

5. The package as claimed in claim 4, wherein the means is a triangular bottom wall provided in a corresponding hole at an upper left corner of the package.

6. The package as claimed in claim 5, wherein the triangular bottom wall has a right-angled configuration.

7. A package for receiving electrical connectors therein in a matrix manner, comprising:
a rectangular base defining a plurality of holes at two opposite end portions thereof and a plurality of the cavities between the holes, both the holes and cavities being adapted for receiving the electrical connectors and being arranged in a matrix;
ribs extending into each of the holes and cavities for supporting a corresponding electrical connector received in said each of the holes and cavities, a distance between the ribs and a surface of the base being large than a height of the corresponding electrical connector;
means provided in one of the holes for helping a user of the package to put the surface of the base at a top side of the base so that the user can put the connectors in the package from the top side of the base, said means having a triangular configuration.

8. A tray for containing electrical connectors therein, comprising:
a base defining a plurality of matrix type first and second cavities, somewhat being similar to each other, respectively on both opposite top and bottom faces of the base, the fist type cavities being adapted to contain the connectors therein while the second cavities being not but for reinforcement or stacking arrangement of the base; wherein
at least one obvious indicating means disposed in at least one of the first cavities to indicate, for easy identification for an operator, that said corresponding top face is intentionally used to contain the corresponding connectors, while said second cavities lack said indicating means, thus preventing improper loading thereon.
